(19) United States
(12) Patent Application Publication
(10) Pub. No.: US 2008/0058011 A1
(43) Pub. Date: Mar. 6, 2008

(54) Apparatus, System and Method for Wireless Transmission for Use in Projection Display Apparatus

(76) Inventors: Wei Lin, Sijhih City (TW); Ming-Li Lin, Sijhih City (TW); Huei-Shiang Chien, Sijhih City (TW)

Correspondence Address: LAW OFFICES OF LAI AND ASSOCIATES, P.C., 5800 RANCHESTER STE 200, HOUSTON, TX, 77036, US

(21) Appl. No.: 11/465,413

(22) Filed: Aug. 17, 2006

(51) Int. Cl. H04B 1/38

(52) U.S. Cl. 455/557; 348/14.01

(57) ABSTRACT

An apparatus, a system and a method for wireless transmission for use in a projection display apparatus are disclosed. The wireless transmission apparatus comprises a wireless transmission controller, a decompression unit, an interface unit and a processor. A wireless signal is received by the wireless transmission controller. The wireless signal comprises a video/audio compression signal and a control signal. The video/audio compression signal is decompressed by the decompression unit to generate a video/audio signal. The interface unit includes an image transmission interface and a serial transmission interface. The video/audio signal and the control signal are transmitted by the processor to the projector from the interface unit. The video/audio signal is transmitted by the image transmission interface to the projection display apparatus. The control signal is transmitted by the serial transmission interface to the projection display apparatus.

### FIELD OF THE INVENTION

The present invention relates to an apparatus, a system and a method for wireless transmission for use in a projection display apparatus and, more particularly, to the apparatus, the system and the method for wireless transmission having an image transmission interface and a serial transmission interface.

### BACKGROUND OF THE INVENTION

Projectors are in widespread use, especially for meeting presentations. The projectors could project a larger screen. Therefore, a user may have a better performance in a larger meeting room when in the presentation.

Referring to FIG. 1, a schematic diagram illustrates a conventional projection display system. The projection display system 10 includes a cable 11, a notebook computer 12 and a projector 13. The cable 11 is electrically connected to the notebook computer 12 and the projector 13. The notebook computer 12 generates a video/audio signal. The video/audio signal is then transmitted by the cable 11 to the projector 13. The projector 13 receives the video/audio signal for displaying and playing.

However, when the space of a meeting room is expanded, the distance between the computer and the projector is also increased. The length of the cable for connecting the projector and the computer is further increased. Consequently, noise may interface with an image signal while transmitting. The quality of the projection screen may not be good enough. In addition, the projector is usually mounted under a ceiling of the meeting room. The user may use a remote controller to control functions of the projector such as adjusting brightness of the screen. If the remote controller is lost or is out of order, the user must climb a table to adjust the functions of the projector that causes inconvenience.

Therefore, the inventor of the present invention based on years of experience on related research and development of the wireless transmission apparatus invents an apparatus, a system and a method for wireless transmission for use in a projection display apparatus to overcome the foregoing shortcomings of the prior arts

### SUMMARY OF THE INVENTION

Accordingly, an object of the present invention is to provide an apparatus, a system and a method for wireless transmission for use in a projection display apparatus to increase convenience for operating the projection display apparatus.

In accordance with the object of the present invention the wireless transmission apparatus for use in the projection display apparatus includes a wireless transmission controller, a decompression unit, an interface unit and a processor. The wireless transmission controller receives a wireless signal through a wireless communication protocol. The wireless signal includes a video/audio compression signal and a control signal. The decompression unit performs a decompression action for the video/audio compression signal to generate a video/audio signal. The interface unit has a digital image transmission interface and a serial transmission interface. The processor converts the video/audio signal into a digital video/audio signal. The digital video/audio signal and the control signal are then transmitted by the interface unit to the projection display apparatus. The digital video/audio signal is transmitted by the digital image transmission interface to the projection display apparatus. The control signal is transmitted by the serial transmission interface to the projection display apparatus.

In addition, the present invention further provides a wireless transmission apparatus for use in a projection display apparatus. The wireless transmission apparatus includes a wireless transmission controller, a decompression unit, an interface unit and a processor. The wireless transmission controller receives a wireless signal through a wireless communication protocols. The wireless signal includes a video/audio compression signal and a control signal. The decompression unit performs a decompression action for the video/audio compression signal to generate a video/audio signal. The interface unit has an analog image transmission interface and a serial transmission interface. The processor transmits the video/audio signal and the control signal to the projection display apparatus through the interface unit. The video/audio signal is transmitted by the analog image transmission interface to the projection display apparatus. The control signal is transmitted by the serial transmission interface to the projection display apparatus.

Moreover, the present invention further provides a wireless transmission system. The wireless transmission system includes a projection display apparatus, a wireless transmission apparatus and a computer apparatus. The projection display apparatus provides a projection display action. The wireless transmission apparatus is electrically connected to the projection display apparatus to provide a wireless transmission function. The computer apparatus transmits a video/audio compression signal and a control signal to the wireless transmission apparatus through a wireless communication protocol. The wireless transmission apparatus performs a decompression action for the video/audio compression signal to generate a video/audio signal. The video/audio signal is then transmitted to the projection display apparatus to perform the projection display action. The wireless transmission apparatus transmits the control signal to the projection display apparatus to perform a control action.

Furthermore, the present invention further provides a method for wireless transmission for use between a projection display apparatus and a computer apparatus. The method includes steps as follows: A wireless transmission apparatus is predetermined for electrically connecting the projection display apparatus. A video/audio compression signal and a control signal are transmitted to the wireless transmission apparatus through the computer apparatus. The video/audio compression signal is decompressed by the wireless transmission apparatus to generate a video/audio signal. The wireless transmission apparatus then transmits the video/audio signal to the projection display apparatus to perform a projection display action. The wireless transmission apparatus also transmits the control signal to the projection display apparatus to perform a control action for the projection display action.

Other features and advantages of the present invention and variations thereof will become apparent from the following description, drawings, and claims.

### BRIEF DESCRIPTION OF THE DRAWINGS

FIG. 1 is a schematic diagram illustrating a conventional projection display system;

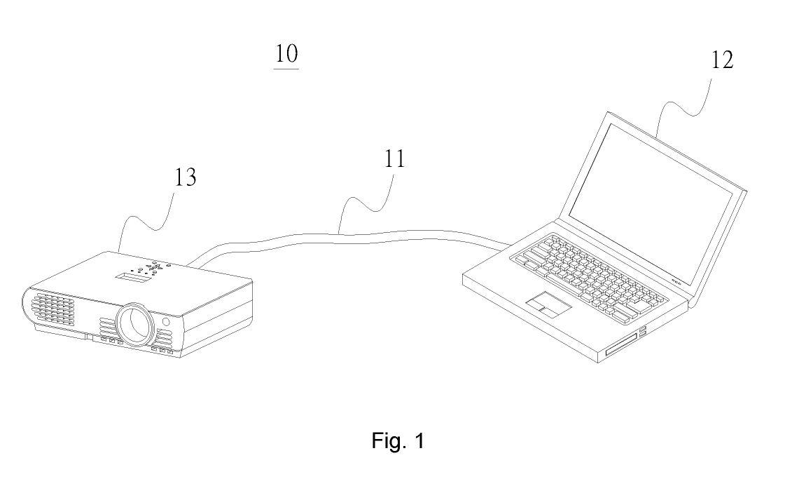

FIG. 2 is a block diagram illustrating a wireless transmission apparatus according to an embodiment of the present invention;

FIG. 3 is a schematic diagram illustrating a wireless transmission apparatus according to a preferred embodiment of the present invention;

FIG. 4 is a block diagram illustrating a wireless transmission apparatus according to another preferred embodiment of the present invention;

FIG. 5 is a block diagram illustrating a wireless transmission system according to an embodiment of the present invention;

FIG. 6 is a schematic diagram illustrating a wireless transmission system according to a preferred embodiment of the present invention;

FIG. 7 is a flowchart illustrating a method for wireless transmission according to an embodiment of the present invention; and

FIG. 8 is a flowchart illustrating a method for wireless transmission according to a preferred embodiment of the present invention

### DETAILED DESCRIPTION OF THE PREFERRED EMBODIMENTS

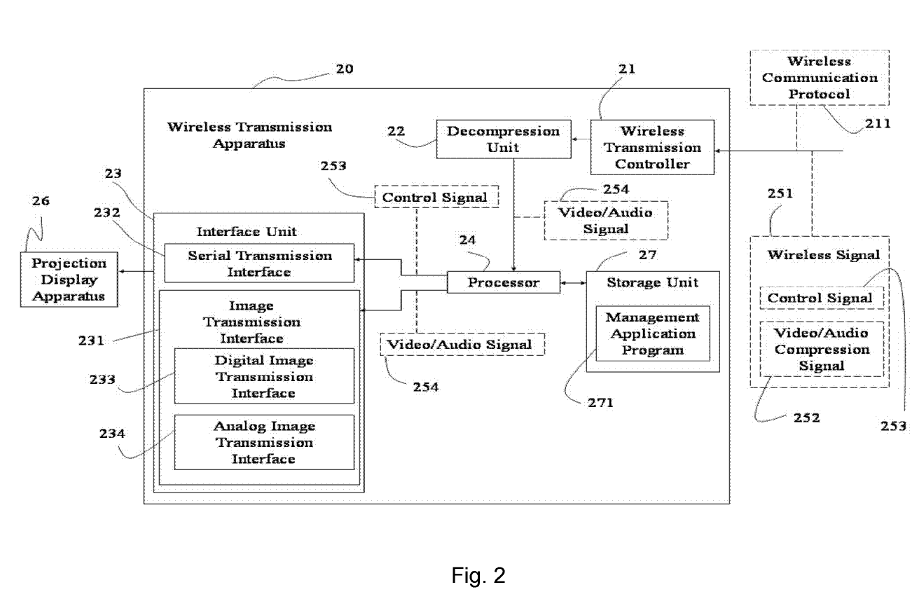

Referring to FIG. 2, a block diagram illustrates a wireless transmission apparatus according to an embodiment of the present invention. The wireless transmission apparatus 20 includes a wireless transmission controller 21, a decompression unit 22, an interface unit 23, a storage unit 27 and a processor 24. The wireless transmission controller 21 receives a wireless signal 251 through a wireless communication protocol 211. The wireless signal 251 includes a video/audio compression signal 252 and a control signal 253. The compression unit 22 performs a decompression action for the video/audio compression signal 252 to generate a video/audio signal 254. The interface unit 23 has an image transmission interface 231 and a serial transmission interface 232. The processor 24 transmits the video/audio signal 254 and the control signal 253 to the projection display apparatus 26 through the interface unit 23. The video/audio signal 254 is transmitted by the image transmission interface 231 to the projection display apparatus 26. The control signal 253 is transmitted by the serial transmission interface 232 to the projection display apparatus 26. The image transmission interface 231 includes a digital image transmission interface 233 or an analog image transmission interface 234. The storage unit 27 is for storing an application program 271 to provide a remote end for downloading.

The wireless transmission controller 21 is a wireless transmission control chip. The wireless communication protocol 211 is Institute of Electrical and Electronics Engineers (IEEE) 802.11X standard. The processor 24 is a microprocessor. The decompression unit 22 is a decompression chip or can be accomplished by the microprocessor executing software. The interface unit 23 is an interface connection port. The serial transmission interface 232 is a RS232 port. The digital image transmission interface 231 is a Digital Visual Interface (DVI) or a High-Definition Multimedia Interface (HDMI) port. The projection display apparatus 26 is a projector. The application program 271 is a project management application program.

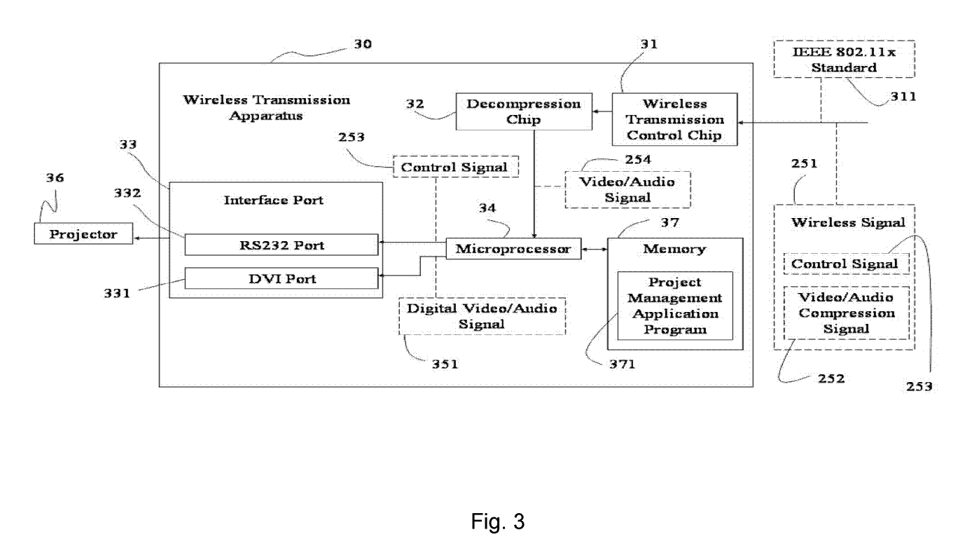

Referring to FIG. 3, a schematic diagram illustrates a wireless transmission apparatus according to a preferred embodiment of the present invention. The wireless transmission apparatus 30 includes a wireless transmission control chip 31, a decompression chip 32, an interface connection port 33, a memory 37 and a microprocessor 34. The wireless transmission control chip 31 receives the wireless signal 251 through IEEE 802.11x standard 311. The IEEE 802.11x standard 311 includes a video/audio compression signal 252 and the control signal 253. The decompression chip 32 performs a decompression action for the video/audio compression signal 252 to generate the video/audio signal 254. The interface connection port 33 has a DVI port 331 and a RS232 port 332. The microprocessor 34 converts the video/audio signal 254 into a digital video/audio signal 351. The digital video/audio signal 351 and the control signal 253 are transmitted by the interface connection port 33 to the projector 36. The digital video/audio signal 351 is transmitted by the DVI port 331 to the projector 36. The control signal 253 is transmitted by the RS232 port 332 to the projector 36. The memory 37 is for storing a project management application program 371 to provide a remote end for downloading.

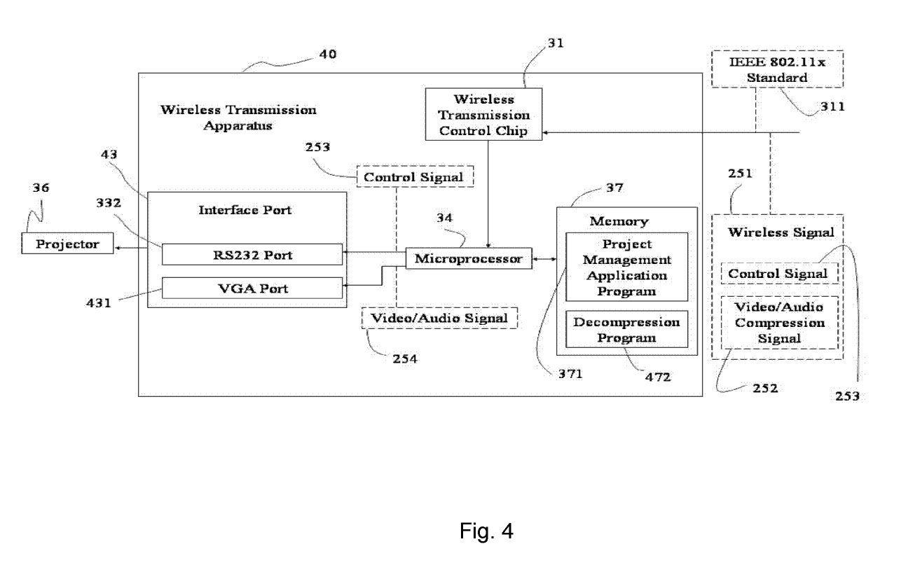

Referring to FIG. 4, a block diagram illustrates a wireless transmission apparatus according to another preferred embodiment of the present invention. The wireless transmission apparatus 40 includes the wireless transmission control chip 31, an interface connection port 43, the memory 37 and the microprocessor 34. The wireless transmission control chip 31 receives the wireless signal 251 through the IEEE 802.11x standard 311. The interface connection port 43 has a VGA port 431 and the RS232 port 332. The memory 37 stores the project management application program and a decompression program 472. The microprocessor 34 performs a decompression action for the video/audio compression signal 252 to generate the video/audio signal 254. The microprocessor 34 then transmits the video/audio signal 254 and the control signal 253 to the projector 36 through interface connection port 43. The video/audio signal 254 is transmitted by the VGA port 431 to the projector 36. The control signal 253 is transmitted by the RS232 port 332 to the projector 36. The project management application program 371 provides a remote end for downloading.

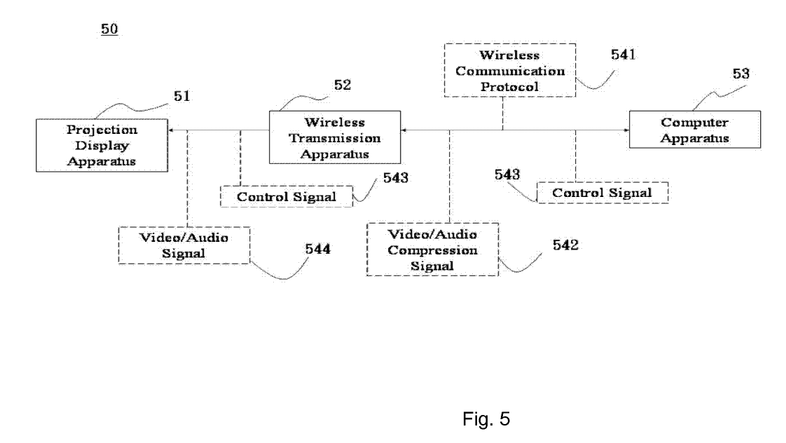

Referring to FIG. 5, a block diagram illustrates a wireless transmission system according to an embodiment of the present invention. The wireless transmission system 50 includes a projection display apparatus 51, a wireless transmission apparatus 52 and a computer apparatus 53. The projection display apparatus 51 provides a projection display action. The wireless transmission apparatus 52 is electrically connected to the projection display apparatus 51 to provide a wireless transmission function. The computer apparatus 53 transmits a video/audio compression signal 542 and a control signal 543 to the wireless transmission apparatus 52 through a wireless communication protocol 541. The wireless transmission apparatus 52 performs a decompression action for the video/audio compression signal 542 to generate a video/audio signal 544. The video/audio signal 544 is then transmitted to the projection display apparatus 51 for performing the projection display action. The wireless transmission apparatus 52 transmits the control signal 543 to the projection display apparatus 51 to perform a control action. The computer apparatus 53 performs an application program to generate the control signal 543. The computer apparatus 53 could download the application program from the wireless transmission apparatus 52. The control action includes controlling the projection display action, a booting action and a shutdown action for the projection display apparatus 51. The projection display apparatus 51 is a projector. The wireless transmission apparatus 52 is an external wireless dongle. The computer apparatus 53 is a notebook computer. The wireless communication protocol 541 is IEEE 802.11x standard. The application program is a project management application program.

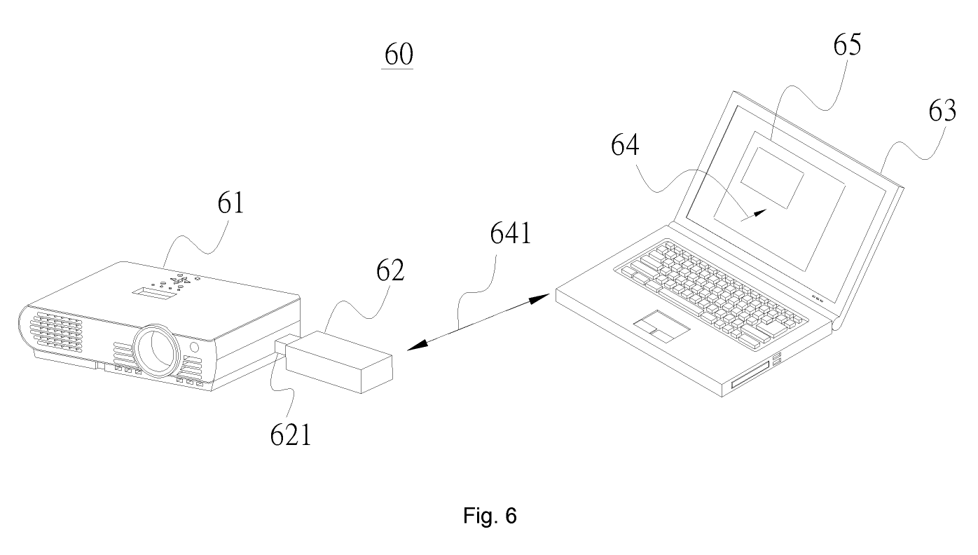

Referring to FIG. 6, a schematic diagram illustrates a wireless transmission system according to a preferred embodiment of the present invention. The wireless transmission system 60 includes a projector 61, an external wireless dongle 62 and a notebook computer 63. The projector 61 provides a projection display action. The external wireless dongle 62 has an interface connection port 621. The interface connection port 621 is electrically connected to the projector 61 to provide a wireless transmission function. The notebook computer 63 transmits the video/audio compression signal 542 and the control signal 543 as shown in FIG. 5 to the external wireless dongle 62 through IEEE 802.11x standard 641. The wireless transmission dongle 62 performs a decompression action for the video/audio compression signal 542 as shown in FIG. 5 to generate the video/audio signal 544. The video/audio signal 544 is then transmitted to the projector 61 for performing the projection display action. The external wireless dongle 62 also transmits the control signal 543 as shown in FIG. 5 to the projector 61 for performing a control action. The notebook computer 63 executes a project management application program 65 to generate the control signal 543 as shown in FIG. 5. Therefore, a user could operate a cursor 64 on a screen of the notebook computer 63 to perform a control action for the projector 61 through the project management application program 65. The control action comprises controlling the projection display action, a booting action and a shutdown action for the projector 61. The control action of the projection display action includes freezing a projection screen of the projector 61, hiding the projection screen of the projector 61 and adjusting brightness, contrast, focusing or zoom-in/zoom-out for the projection screen of the projector 61. The notebook computer 63 could download the project management application program 65 from the external wireless dongle 62.

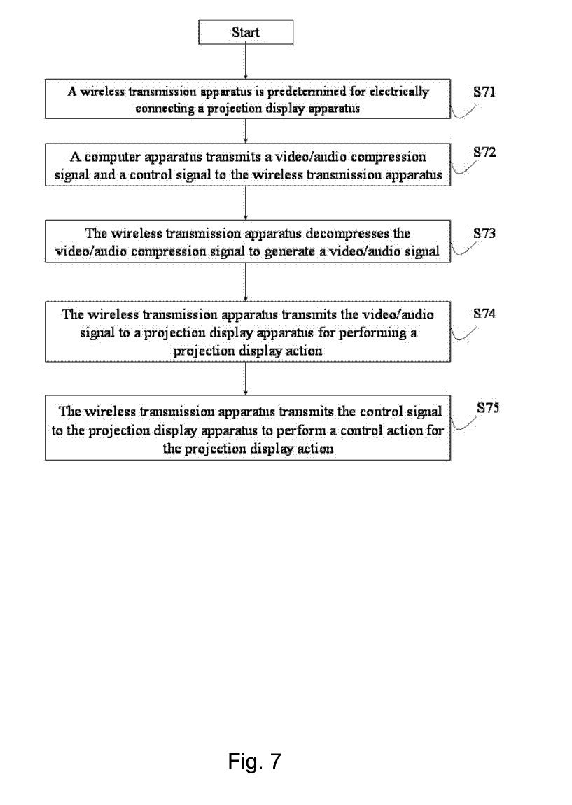

Referring to FIG. 7, a flowchart illustrates a method for wireless transmission according to an embodiment of the present invention. The method includes following steps.

Step S71: A wireless transmission apparatus is predetermined for electrically connecting a projection display apparatus.

Step S72: A computer apparatus transmits a video/audio compression signal and a control signal to the wireless transmission apparatus.

Step S73: The wireless transmission apparatus decompresses the video/audio compression signal to generate a video/audio signal.

Step S74: The wireless transmission apparatus transmits the video/audio signal to a projection display apparatus for performing a projection display action.

Step 75: The wireless transmission apparatus transmits the control signal to the projection display apparatus to perform a control action for the projection display action.

The computer apparatus executes an application program to generate the control signal. The computer apparatus could download the application program from the wireless transmission apparatus. The projection display apparatus is a projector. The wireless transmission apparatus is an external wireless dongle. The computer apparatus is a notebook computer. The wireless communication protocol is IEEE 802.11x standard. The application program is a project management application program. The control action includes controlling the projection display action, a booting action and a shutdown action for the projection display apparatus. Controlling the projection display action includes freezing a projection screen of the projection display apparatus, hiding the projection screen of the projection display apparatus and adjusting brightness, contrast, focusing or zoom-in/zoom-out for the projection screen of the projection display apparatus.

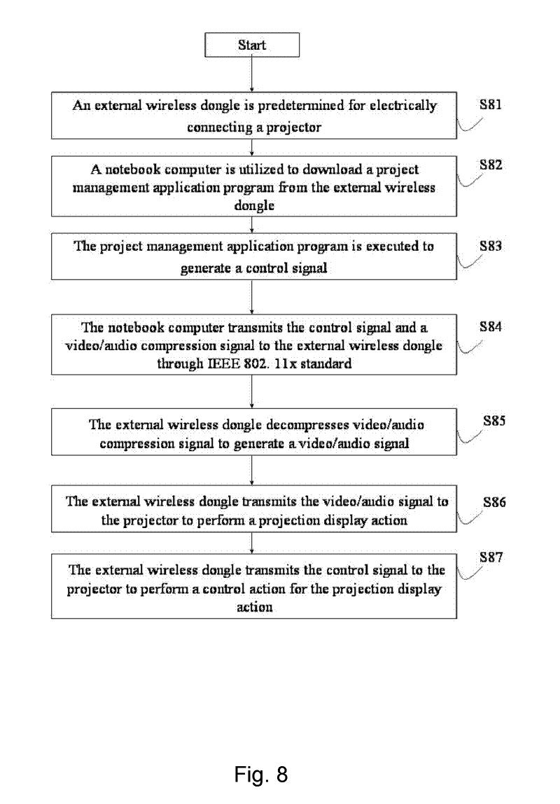

Referring to FIG. 8, a flowchart illustrates a method for wireless transmission according to a preferred embodiment of the present invention. The method includes following steps.

Step S81: An external wireless dongle is predetermined for electrically connecting a projector.

Step S82: A notebook computer is utilized to download a project management application program from the external wireless dongle.

Step S83: The project management application program is executed to generate a control signal.

Step S84: The notebook computer transmits the control signal and a video/audio compression signal to the external wireless dongle through IEEE 802.11x standard.

Step S85: The external wireless dongle decompresses video/audio compression signal to generate a video/audio signal.

Step S86: The external wireless dongle transmits the video/audio signal to the projector to perform a projection display action.

Step S87: The external wireless dongle transmits the control signal to the projector to perform a control action for the projection display action.

The control action includes controlling the projection display action, a booting action and a shutdown action for the projection display apparatus. Controlling the projection display action includes freezing a projection screen of the projection display apparatus, hiding the projection screen of the projection display apparatus and adjusting brightness, contrast, focusing or zoom-in/zoom-out for the projection screen of the projection display apparatus.

Although the features and advantages of the embodiments according to the preferred invention are disclosed, it is not limited to the embodiments described above, but encompasses any and all modifications and changes within the spirit and scope of the following claims.

What is claimed is:

1. A wireless transmission apparatus for use in a projection display apparatus, comprising:
a wireless transmission controller for receiving a wireless signal through a wireless communication protocol, said wireless signal including a video/audio compression signal and a control signal;
a decompression unit for performing a decompression action for said video/audio compression signal to generate a video/audio signal;
an interface unit having a digital image transmission interface and a serial transmission interface; and
a processor for converting said video/audio signal into a digital video/audio signal, said digital video/audio signal and said control signal being transmitted to said projection display apparatus through said interface unit;
wherein said digital video/audio signal is transmitted to said projection display apparatus through said digital image transmission interface, and said control signal is transmitted to said projection display apparatus through said serial transmission interface.

2. A wireless transmission apparatus for use in a projection display apparatus, comprising:
a wireless transmission controller for receiving a wireless signal through a wireless communication protocol, said wireless signal including a video/audio compression signal and a control signal;
a decompression unit for performing a decompression action for said video/audio compression signal to generate a video/audio signal;
an interface unit having a serial transmission interface and a Digital Visual Interface (DVI) or a High-Definition Multimedia Interface (HDMI) port; and
a processor for converting said video/audio signal into a digital video/audio signal, and said digital video/audio signal and said control signal being transmitted to said projection display apparatus through said interface unit;
wherein said digital video/audio signal is transmitted to said projection display apparatus through said DVI, and said control signal is transmitted to said projection display apparatus through said serial transmission interface.

3. The wireless transmission apparatus of claim 1 or 2, wherein said wireless transmission apparatus further comprises a storage unit, and said storage unit is for storing an application program to provide a remote end for downloading.

4. The wireless transmission apparatus of claim 1 or 2, wherein said wireless communication protocol is Institute of Electrical and Electronics Engineers (IEEE) 802.11x. standard.

5. The wireless transmission apparatus of claim 1 or 2, wherein said decompression unit is a decompression chip or software.

6. A method for wireless transmission for use between a computer apparatus and a projection display apparatus, comprising:
predetermining a wireless transmission apparatus for electrically connecting said projection display apparatus;
transmitting a video/audio compression signal and a control signal to said wireless transmission apparatus through said computer apparatus;
decompressing said video/audio compression signal to generate a video/audio signal through said wireless transmission apparatus;
transmitting said video/audio signal to said projection display apparatus through said wireless transmission apparatus so as to perform a projection display action; and
transmitting said control signal to said projection display apparatus through said wireless transmission apparatus so as to perform a control action for said projection display apparatus.

7. The method for wireless transmission of claim 6, further comprising the step of executing an application program in said computer apparatus to generate said control signal.

8. The method for wireless transmission of claim 7, further comprising the step of downloading said application program from said wireless transmission apparatus.

9. The method for wireless transmission of claim 6, further comprising the step of providing an external wireless dongle to be said wireless transmission apparatus.

10. The method for wireless transmission of claim 6, further comprising the step of controlling said projection display action to be said control action.

11. The method for wireless transmission of claim 6, further comprising the step of providing a booting action of said projection display apparatus and a shutdown action of said projection display apparatus to be said control action.

12. The method for wireless transmission of claim 10, further comprising the step of freezing a projection screen of said projection display apparatus, hiding said projection screen of said projection display apparatus and adjusting parameters of said projection screen of said projection display apparatus to be said controlling said projection display action.
